(19) United States
(12) Patent Application Publication
(10) Pub. No.: US 2009/0101033 A1
(43) Pub. Date: Apr. 23, 2009

(54) Oscillating ink form roller

(76) Inventor: Kevin T. Byer, Farmington, NY (US)

Correspondence Address: SANFORD J. PILTCH, ESQ., 1132 HAMILTON STREET, SUITE 201, ALLENTOWN, PA, 18101, US

(21) Appl. No.: 12/288,828

(22) Filed: Oct. 23, 2008

Related U.S. Application Data
(63) Continuation-in-part of application No. 61/000,057, filed on Oct. 23, 2007.

(51) Int. Cl. B41F 31/02

(52) U.S. Cl. 101/367

(57) ABSTRACT

The present invention is an adjustable oscillating ink form or roller that moves freely back and forth along its axis of rotation to create a more efficient inking of the printing plate of a high-speed web printing press by allowing for a more even distribution of ink onto the printing plate in a more consistent manner. The back and forth oscillation is especially useful in preventing image “ghosting” that forms on the printed page when the ink thickness diminishes.

### BACKGROUND OF THE INVENTION

The invention relates to the inking of high-speed web printing presses. High-speed web printing is a widely used printing technique where the inked image is transferred from a plate to a rubber blanket, then to the printing surface. Some advantages of high speed web printing compared to other printing methods are consistent high image quality and production of sharper, cleaner images and type than letterpress printing for the reason that the rubber blanket conforms to the texture of the printing surface. Additionally, the production of the printing plates is quick and easy and the printing plate life is longer than on direct lithographic presses, since there is no direct contact between the plate and the printing surface.

The present invention is an oscillating ink form, which is designed as an intermediary roller between the inking roller and the high speed plate. The oscillating ink form is designed differently than prior inking forms. The present invention is permitted to move freely back and forth within preset lateral motion limiters, to allow a more even distribution of the ink onto the high speed plate that prints on the paper.

One problem with earlier ink forms is that these ink forms were static, i.e., locked in a single position, and thus, unable to laterally move within the confines of the horizontal dimensions of the press. In this manner, ink being deposited on the intermediate roller or on the rubber blanket was unevenly distributed across the printing surface. Due to the non-oscillating nature of earlier ink forms “ghosting” occurred on the printed page, which is a slightly offset secondary image of the primary image. “Ghosting” can occur because the thickness of the deposited ink diminishes during transference. Therefore a need exists for an ink form that prevents the occurrence of “ghosting” by employing a laterally offset motion for the indirect transference of the ink for the high speed presses to avoid ink thickness differences on either the secondary transfer roller or the rubber blanket.

A need also exists for an ink form roller that achieves a more uniform inking of the inking transfer roller, and ultimately the printing plate (or rubber blanket) by allowing for a slight lateral motion of the inking form along its axis. This will achieve a more even distribution of ink onto the printing plate in a continuing, consistent manner and is especially useful in preventing horizontal and vertical lines that form when the ink thickness diminishes. Moreover, a need also exists for an ink form that prevents the fading of bold letter characters and reprinted photos. The present invention will permit minimal lateral displacement of the inking form along its axis (support shaft) within preset motion limiters to create the more uniform distribution of ink across the width of the press assembly.

### SUMMARY OF THE INVENTION

The present invention is an oscillating ink form used in place of the standard large ink form, or the outside ink form, in the ink train of a high-speed printing press. The benefit of using an oscillating ink form is to create a more uniform distribution of ink across the width of the print rollers of the press and to reduce or eliminate “ghosting” resulting in better print quality.

The ink form roller is assembled using a hollow core, an elongated shaft, a pair of washers, two split collar motion limiters, a pair of linear rotary bearings and a pair of snap rings. A rubber covering is applied to the outer surface of the core to form the ink form roller. The ink form roller is mounted on a stationary solid shaft that runs through the hollowed middle of the ink form roller. When installed in the ink train of the high-speed press, the shaft is bolted to the frame, so that the roller can spin freely about the pair of linear rotary bearings, as well as travel back and forth, i.e., oscillate, along the rotational axis of the ink form roller within lateral motion limits set by the pair of split collar motion limiters. This is accomplished without any movement of the static shaft, although the ink form roller rotates at press speed.

It is an object of the present invention to have the pair of split collar motion limiters positioned at substantially identical distances outward of the ink form roller core along the stationary shaft to allow the ink form roller to freely oscillate back and forth within the distance limited by the collars to provide a more uniform ink distribution to the transference roller and to the printing form. The ink form roller will rotate at machine speed, oscillating between the collars in following the associated drive roller, to distribute the ink along the desired ink width of the ink transference rollers of the press.

It is another object of the present invention to have an ink form roller where the amount of the oscillation is adjustable in accordance with the placement of the paired split collar motion limiters so that the ink form roller may oscillate within a range of ¼ of an inch to 1 inch or more, according to the needs of the user.

Other features and advantages of the invention are described below.

### BRIEF DESCRIPTION OF THE DRAWING

For the purpose of illustrating the invention, there is shown in the drawing a form which is presently preferred; it being understood, however, that the invention is not limited to the precise arrangements and instrumentalities shown.

FIG. 1 is a partial cutaway side view of the oscillating ink form roller assembly of the present invention.

FIG. 2 is a schematic view of the series of rollers from the ink fountain roller to the plate and blanket cylinder rollers.

### DETAILED DESCRIPTION OF THE INVENTION

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawing.

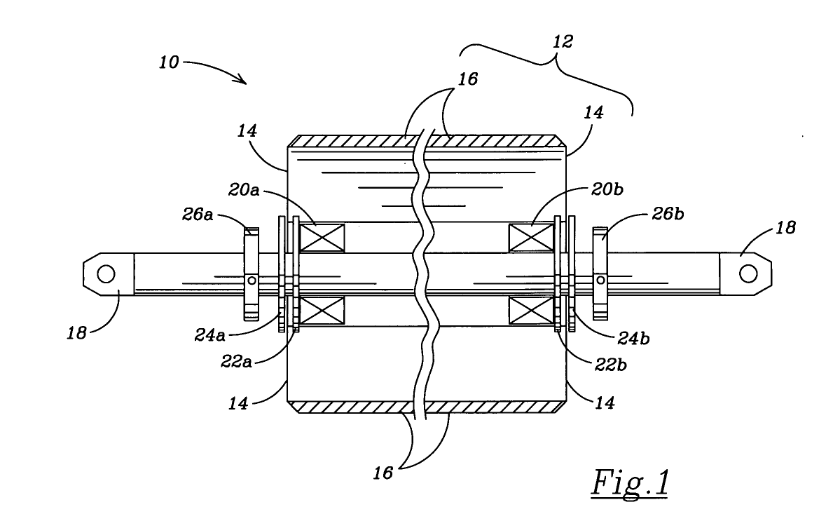

As illustrated in FIG. 1, the oscillating ink form system 10 is assembled using a hollow core 14, which is cylindrical in shape, about which a rubber cover 16 is applied to create the ink form or roller 12. A solid elongated shaft 18, about which the hollow core 14 and rubber covering 16 will rotate, extends through the core 14. In order that the ink form or roller 12 can rotate about the shaft 18, a pair of linear rotary bearings 20a, 20b are press-fitted into the cylindrical hollow space within the core 14 a predetermined distance inward from the respective rims of both ends of the core 14 and a pair of snap rings 22a, 22b are positioned into respective slots precut inside the core 14 to retain the liner rotary bearings 20a, 20b in their predetermined positions during use of the form or roller 12.

Completing the assembly of the oscillating ink form system 10, the shaft is inserted through the hollow core 14 of the ink form or roller 12, through the central aperture of each of the linear rotary bearings 20a, 20b. The ink form or roller 12 is centered on the shaft 18 and a pair of motion permitting washers or spacers 24a, 24b, are placed outward and at either side of the ink form or roller 12 along the shaft 18. Finally, a pair of split collar motion limiters 26a, 26b are positioned along the shaft 18 outward from the ink form or roller 12 a predetermined distance such that the ink form or roller 12 is capable of both free rotation about, and limited lateral motion along the shaft 18. The motion limiters 26a, 26b can be located at any desired distance away from the ends of the ink form or roller 12 to permit the free oscillation within the limited lateral distance between the motion limiters 26a, 26b. It is preferred, although not required, to position the motion limiters 26a, 26b at positions that are equidistant from either the center or the ends of the shaft 18 so that the ink form or roller 12 performs its rotational translation symmetrically along the length of the shaft between the motion limiters 26a, 26b. If non-symmetrical oscillation is required, the motion limiters 26a, 26b may be positioned at unequal distances to accommodate this requirement.

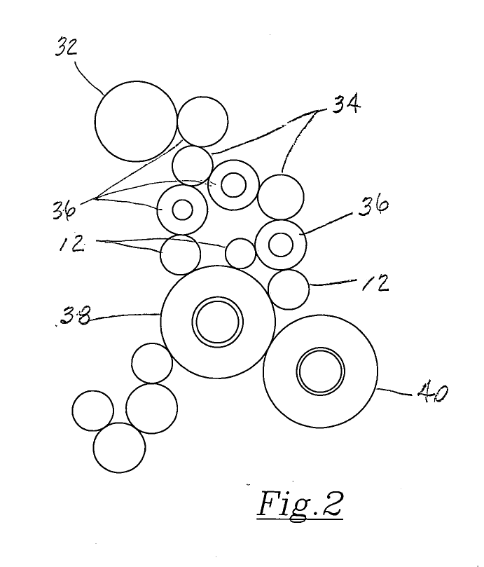

The ink form or roller 12, which is rotationally mounted about the elongated shaft 18 that runs through the hollow center of the ink form or roller 12, is installed onto the press by bolting the opposite ends of the shaft 18 to the high-speed printing press frame. With reference to FIG. 2, there may be a number of placements for the ink form rollers 12 of the present invention in the roller series for inking high-speed presses. Starting in the upper left with the ink fountain roller 32, this roller transfers the ink from the fountain (not shown) to one or more of ink transfer rollers 34 utilizing intermediary ink oscillator rollers 36. These ink oscillator rollers also are intermediate the ink transfer rollers 34 and the one or more ink form rollers 12 of the present invention. The ink form rollers 12, in turn, contact the printing plate cylinder roller 38, transferring the ink so that “ghosting” does not occur when the ink is transferred to the blanket roller 40 for printing on the desired print surface.

Each of any ink form rollers 12 present in the ink train system for the press is driven rotationally by the adjacent ink oscillator roller 36 and also laterally as the ink oscillator rollers 36 move laterally in accordance with the preferred scope of motion set for the individual print job. In this manner the ink form or roller 12 will freely rotate at press speed, without impediment, about the fixed, stationary shaft 18 and oscillate back and forth along the shaft 18 within the limited lateral spacings of the motion limiters 26a, 26b. It is important to not that the lateral motion of the ink form roller 12 may be set to mimic the ink oscillator rollers 36 or be set to limit to lateral motion of the roller. The lateral, oscillating motion of the ink form or roller 12 provides for the more even distribution of ink within the ink train of the high-speed press.

The linear rotary bearings 20a, 20b that are used to mount the may ink form or roller 12 to the shaft 18 are preferred to be made of aluminum alloy or stainless steel, are cylindrical in shape with a hollowed out core, are capable of self alignment when placed in the desired position, and may range in length (for the present application) from 3 inches up to 8 inches. The overall distance between each of the motion limiters 26a, 26b is larger than the overall length dimension of the ink form or roller 12 and the washers 24a, 24b to permit the uninhibited lateral motion, i.e., the free rotational oscillation, of the ink form or roller 12.

The present invention may be embodied in other specific forms without departing from the spirit or essential attributes thereof and, accordingly, the described embodiments are to be considered in all respects as being illustrative and not restrictive.

1. A self-oscillating ink form roller assembly comprising:
an elongate stationary shaft extending between a pair of opposed fixed ends;
a hollow core concentrically mounted about said shaft, said core being adapted for free rotational and lateral motion about and along said shaft and being substantially coextensive with said shaft;
means for rotationally mounting said hollow core to said shaft for lateral translational movement axially along said shaft;
means for adjustably limiting the lateral translational movement of said hollow core;
an ink transferring cover mounted about the exterior of the hollow core; and,
a drive roller mounted in juxtaposed relation opposing said ink form roller to provide both rotational and lateral translational motion to the ink form roller.

2. The self-oscillating ink form roller of claim 1, wherein said means for rotationally mounting the hollow core about the stationary shaft are at least a pair of linear rotary bearings.

3. The self-oscillating ink form roller of claim 1, wherein said means for adjustably limiting the lateral movement of said hollow core are a pair of motion limiters.

4. The pair of motion limiters of claim 3, wherein the positioning of the motion limiters may be symmetrical or offset from the center point of said stationary shaft.

5. The drive roller of claim 1, wherein said roller provides the rotational and lateral translational motion by direct contact between the rollers.
